(19) United States
(12) Patent Application Publication
(10) Pub. No.: US 2021/0112840 A1
(43) Pub. Date: Apr. 22, 2021

(54) POTATO SALAD PRE-MIX COMPOSITION

(71) Applicant: Christine Amos, Elkton, MD (US)

(72) Inventor: Christine Amos, Elkton, MD (US)

(21) Appl. No.: 16/654,134

(22) Filed: Oct. 16, 2019

(51) Int. Cl. A23L 27/60; A23L 27/18; A23L 27/40; A23L 27/30; A23L 19/12

(52) U.S. Cl. CPC A23L 27/60; A23L 27/18; A23V 2002/00; A23L 27/33; A23L 19/12; A23L 27/40

(57) ABSTRACT

Disclosed is a potato salad pre-mix composition. The potato salad pre-mix composition may include about 48.18% by weight mayonnaise. Further, the potato salad pre-mix composition may include about 38.04% by weight salt. Further, the potato salad pre-mix composition may include about 4.73% by weight yellow mustard. Further, the potato salad pre-mix composition may include about 4.22% by weight sugar. Further, the potato salad pre-mix composition may include about 4.83% by weight vinegar.

### TECHNICAL FIELD

Generally, the present disclosure relates to food compositions. More specifically, the present disclosure relates to a potato salad pre-mix composition.

### BACKGROUND

For millions of families in North America and Europe, potato salad is a standard side dish of many meals. A broad variety of recipes have been developed by some of these families, and many have been developed and sold commercially. However, although all recipes require potatoes and eggs to be cooked, these generally do not offer any feature supporting an instant or rapid preparation time for the additional ingredients to be mixed with cooked potatoes and eggs.

Therefore, there is a need for a food composition that may enable a user to quickly prepare a potato salad that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed is a potato salad pre-mix composition. The potato salad pre-mix composition may include about 48.18% by weight mayonnaise. Further, the potato salad pre-mix composition may include about 38.04% by weight salt. Further, the potato salad pre-mix composition may include about 4.73% by weight yellow mustard. Further, the potato salad pre-mix composition may include about 4.22% by weight sugar. Further, the potato salad pre-mix composition may include about 4.83% by weight vinegar.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of a small-sized jar containing a potato salad pre-mix composition, in accordance with some embodiments.

FIG. 2 is a front top perspective view of the small-sized jar containing the potato salad pre-mix composition, in accordance with some embodiments.

FIG. 3 is a front view of a medium-sized jar containing a potato salad pre-mix composition, in accordance with some embodiments.

FIG. 4 is a front top perspective view of the medium-sized jar containing the potato salad pre-mix composition, in accordance with some embodiments.

FIG. 5 is a front view of a large-sized jar containing a potato salad pre-mix composition, in accordance with some embodiments.

FIG. 6 is a front top perspective view of the large-sized jar containing the potato salad pre-mix composition, in accordance with some embodiments.

FIG. 7 is a table corresponding to recipes, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of potato salad pre-mix composition, embodiments of the present disclosure are not limited to use only in this context.

Overview:

According to some embodiments, the present disclosure is directed to a potato salad pre-mix composition. The composition enables the user to quickly prepare cooked potatoes and eggs with diced celery, diced onions, and off the shelf ingredients. The composition comprises of one or more of mayonnaise, mustard, sugar, salt, and vinegar. The composition is preferably comprised of Kraft™ brand food products wherever possible.

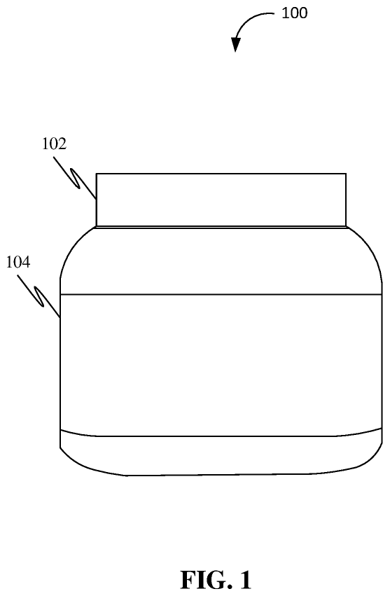

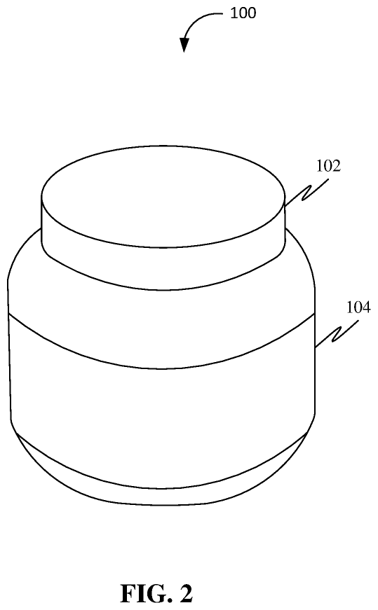

FIG. 1 is a front view of a small-sized jar 100 containing a potato salad pre-mix composition, in accordance with some embodiments. FIG. 2 is a front top perspective view of the small-sized jar 100 containing the potato salad pre-mix composition, in accordance with some embodiments. The small-sized jar 100 includes a lid 102, and a label 104. The small-sized jar 100 may contain 11.25-ounces of the potato salad pre-mix composition.

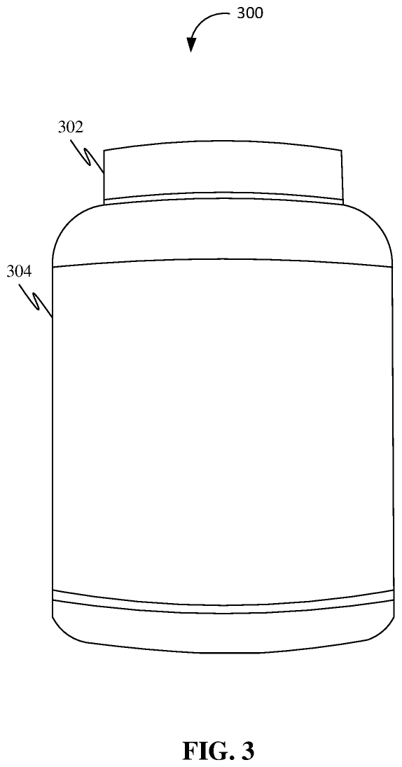

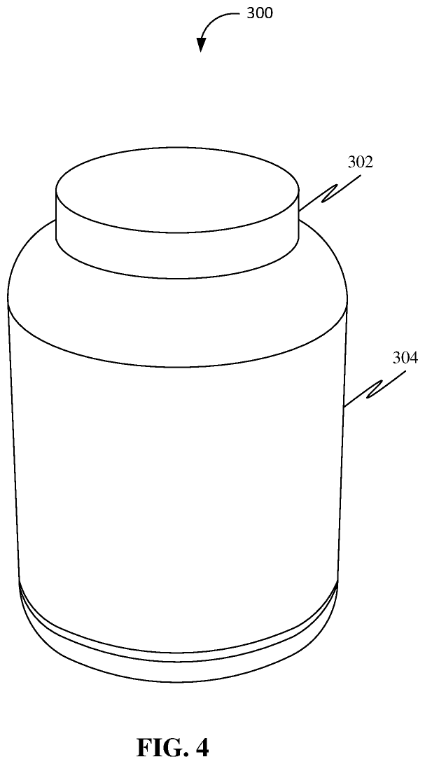

FIG. 3 is a front view of a medium-sized jar 300 containing a potato salad pre-mix composition, in accordance with some embodiments. FIG. 4 is a front top perspective view of the medium-sized jar 300 containing the potato salad pre-mix composition, in accordance with some embodiments. The medium-sized jar 300 includes a lid 302, and a label 304. The medium-sized jar 300 may contain 22.5-ounces of the potato salad pre-mix composition.

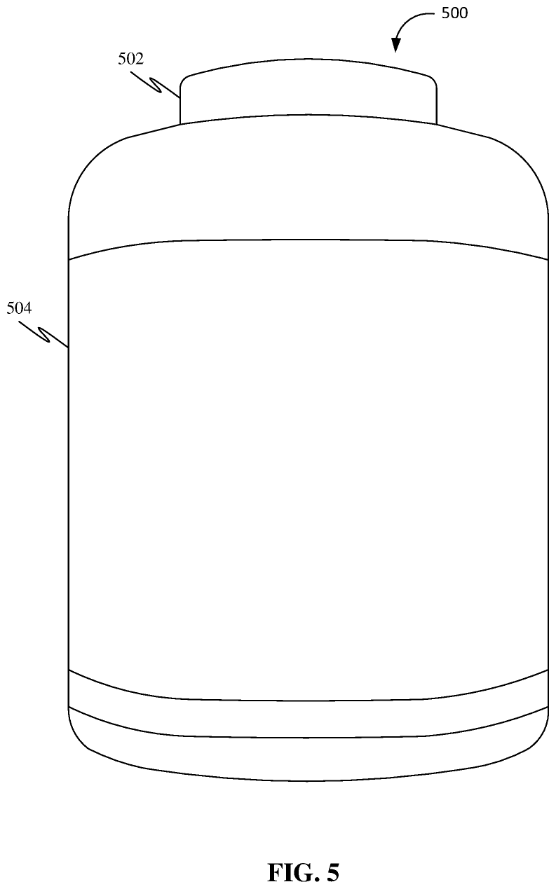

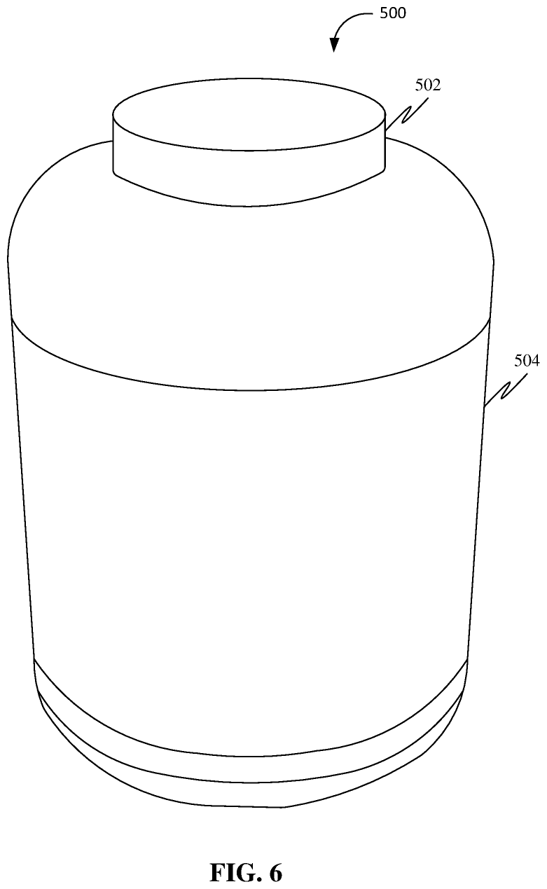

FIG. 5 is a front view of a large-sized jar 500 containing a potato salad pre-mix composition, in accordance with some embodiments. FIG. 6 is a front top perspective view of the large-sized jar 500 containing the potato salad pre-mix composition, in accordance with some embodiments. The large-sized jar 500 includes a lid 502, and a label 504. The large-sized jar 500 may contain 45-ounces of the potato salad pre-mix composition.

According to some embodiments, the potato salad pre-mix composition includes one or more of mayonnaise, mustard, sugar, salt, and vinegar. The composition may be preferably packaged in jars in three sizes: the small-sized jar 100, the medium-sized jar 300 and the large-sized jar 500. Each jar provides a lid and a label of proportionate sizes.

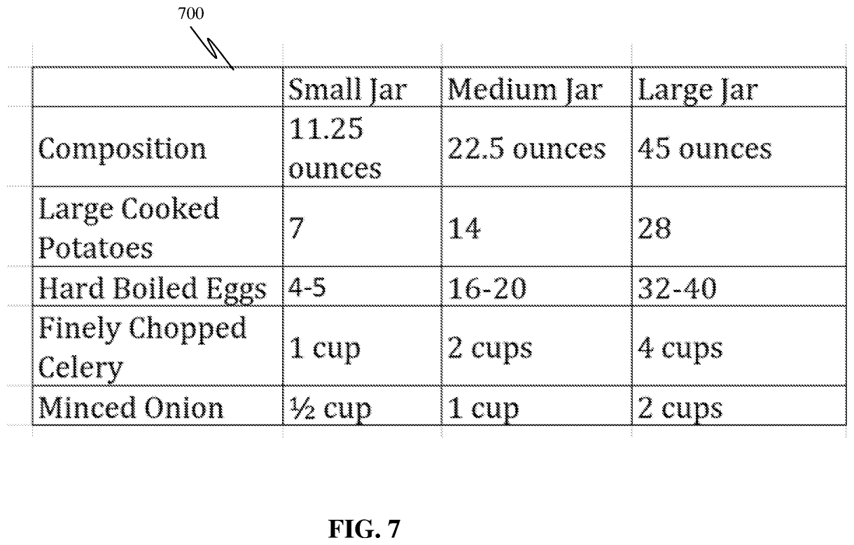

A recipe for the mixture of the composition with cooked potatoes, boiled eggs, diced celery, and diced onion is printed on the labels (104, 304, 504), recommending a mixture in the proportions as shown in a table 700 in FIG. 7. As per the table 700, the potato salad pre-mix composition from the small-sized jar 100 may be mixed with 7 large cooked potatoes, 4-5 hard-boiled eggs, 1 cup finely chopped celery and ½ cup minced onion. As per the table 700, the potato salad pre-mix composition from the medium-sized jar 300 may be mixed with 14 large cooked potatoes, 16-20 hard-boiled eggs, 2 cups finely chopped celery and 1 cup minced onion. As per the table 700, the potato salad pre-mix composition from the large-sized jar 500 may be mixed with 28 large cooked potatoes, 32-40 hard-boiled eggs, 4 cups finely chopped celery and 2 cups minced onion.

Optionally, the printed recipe may also include ground black pepper and other off the shelf ingredients. The potatoes must be peeled and diced before cooking. The eggs must be peeled and diced after cooking. Until the seal on the lid 11 is broken, the composition may be stored at room temperature.

The measurements of the composition and the quantity sizes may be altered by the manufacturer, so as to fit their containers of their product lines. Only the key ingredients and the measurements that are needed to make up for a specific size may not be altered.

According to some embodiments, the contents of the potato salad pre-mix composition for the family serving size may be as follows:
1¼ coup of mayonnaise
½ teaspoons salt
2 teaspoons yellow mustard
2 teaspoons sugar
2 teaspoons vinegar

One or more of the following may be added to the potato salad pre-mix composition:
5-7 medium boiled potatoes
4-6 boiled eggs
1 cup of fine chopped celery
½ cups minced or diced onions

To use the potato salad pre-mix composition in the small-sized jar 100, the user may open the lid 102, pour the potato salad pre-mix composition out of the small-sized jar 100 into a mixing bowl, and mix in the ingredients specified on the label 104.

To use the potato salad pre-mix composition in the medium-sized jar 300, the user may open the lid 302, pour the potato salad pre-mix composition out of the medium-sized jar 300 into a mixing bowl, and mix in the ingredients specified on the label 304.

To use the potato salad pre-mix composition in the large-sized jar 500, the user may open the lid 502, pour the potato salad pre-mix composition out of the large-sized jar 500 into a mixing bowl, and mix in the ingredients specified on the label 504.

According to some embodiments, the potato salad pre-mix composition may include one or more of about 1¼ cups of mayonnaise, about ½ teaspoons salt, about 2 teaspoons yellow mustard, about 2 teaspoons sugar and about 2 teaspoons vinegar.

Further, the mayonnaise may include at least one of soybean oil, water, eggs, vinegar, contains less than 2% of sugar, salt, egg yolks, natural flavor, mustard), lemon juice concentrate, calcium disodium Ethylenediaminetetraacetic acid (EDTA), dried garlic, dried onions, and paprika.

Further, the salt may include sodium chloride (NaCl). Further, the yellow mustard may include one or more of ground mustard seeds, water, vinegar, lemon juice, wine, salt, flavorings and spices. Further, the sugar may include one or more of sucrose, glucose and fructose. Further, the vinegar may include 5-20% acetic acid by volume.

Further, the potato salad pre-mix composition may be packaged in one of the small-sized jar 100, the medium-sized jar 300 and the large-sized jar 500. The small-sized jar 100 may contain 11.25 ounces of the potato salad pre-mix composition. The medium-sized jar 300 may contain 22.5 ounces of the potato salad pre-mix composition. The large-sized jar 500 may contain 45 ounces of the potato salad pre-mix composition.

Further, the potato salad pre-mix composition may be mixed with one or more of cooked potatoes, boiled eggs, diced celery, and diced onion to obtain potato salad.

In some embodiments, 11.25 ounces of the potato salad pre-mix composition may be mixed with one or more of 7 cooked potatoes, 4 boiled eggs, 1 cup diced celery, and half-cup diced onion to obtain potato salad.

In some embodiments, 22.5 ounces of the potato salad pre-mix composition is mixed with one or more of 14 cooked potatoes, 16 boiled eggs, 2 cups diced celery, and 1 cup diced onion to obtain potato salad.

In some embodiments, 45 ounces of the potato salad pre-mix composition is mixed with one or more of 28 cooked potatoes, 32 boiled eggs, 4 cups diced celery, and 2 cups diced onion to obtain potato salad.

According to some embodiments, the potato salad pre-mix composition may include one or more of about 48.18% by weight mayonnaise, about 38.04% by weight salt, about 4.73% by weight yellow mustard, about 4.22% by weight sugar and about 4.83% by weight vinegar.

The potato salad pre-mix composition enables the users to quickly prepare potato salad from cooked potatoes and eggs. The potato salad pre-mix composition enables the user to prepare potato salad from cooked potatoes and eggs with diced celery, diced onions, and off the shelf ingredients in only a few minutes.

Components, component sizes, and materials listed above are preferable, but artisans will recognize that alternate components and materials could be selected without altering the scope of the invention.

Although the present disclosure has been explained in relation to its preferred embodiment, it is to be understood that many other possible modifications and variations can be made without departing from the spirit and scope of the disclosure.

We claim:

1. A potato salad pre-mix composition, wherein a family size serving of the composition consists of:
about 1¼ cups of mayonnaise;
about ½ teaspoons salt;
about 2 teaspoons yellow mustard;
about 2 teaspoons sugar; and
about 2 teaspoons vinegar.

2. The potato salad pre-mix composition of claim 1, wherein the mayonnaise includes at least one of soybean oil, water, eggs, vinegar, contains less than 2% of sugar, salt, egg yolks, natural flavor, mustard), lemon juice concentrate, calcium disodium Ethylenediaminetetraacetic acid (EDTA), dried garlic, dried onions, and paprika.

3. The potato salad pre-mix composition of claim 1, wherein the salt is sodium chloride (NaCl).

4. The potato salad pre-mix composition of claim 1, wherein the yellow mustard includes one or more of ground mustard seeds, water, vinegar, lemon juice, wine, salt, flavorings and spices.

5. The potato salad pre-mix composition of claim 1, wherein the sugar includes one or more of sucrose, glucose and fructose.

6. The potato salad pre-mix composition of claim 1, wherein the vinegar includes 5-20% acetic acid by volume.

7. The potato salad pre-mix composition of claim 1 is packaged in one of a small-sized jar, a medium-sized jar and a large-sized jar, wherein the small-sized jar contains 11.25 ounces of the potato salad pre-mix composition, wherein the medium-sized jar contains 22.5 ounces of the potato salad pre-mix composition, wherein the large-sized jar contains 45 ounces of the potato salad pre-mix composition.

8. The potato salad pre-mix composition of claim 1 is mixed with one or more of cooked potatoes, boiled eggs, diced celery, and diced onion to obtain potato salad.

9. The potato salad pre-mix composition of claim 1, wherein 11.25 ounces of the potato salad pre-mix composition is mixed with one or more of 7 cooked potatoes, 4 boiled eggs, 1 cup diced celery, and half-cup diced onion to obtain potato salad.

10. The potato salad pre-mix composition of claim 1, wherein 22.5 ounces of the potato salad pre-mix composition is mixed with one or more of 14 cooked potatoes, 16 boiled eggs, 2 cups diced celery, and 1 cup diced onion to obtain potato salad.

11. The potato salad pre-mix composition of claim 1, wherein 45 ounces of the potato salad pre-mix composition is mixed with one or more of 28 cooked potatoes, 32 boiled eggs, 4 cups diced celery, and 2 cups diced onion to obtain potato salad.

12. A potato salad pre-mix composition, wherein the composition consists of:
about 48.18% by weight mayonnaise;
about 38.04% by weight salt;
about 4.73% by weight yellow mustard;
about 4.22% by weight sugar; and
about 4.83% by weight vinegar.

13. The potato salad pre-mix composition of claim 12, wherein the mayonnaise includes at least one of soybean oil, water, eggs, vinegar, contains less than 2% of sugar, salt, egg yolks, natural flavor, mustard), lemon juice concentrate, calcium disodium Ethylenediaminetetraacetic acid (EDTA), dried garlic, dried onions, and paprika.

14. The potato salad pre-mix composition of claim 12, wherein the salt is sodium chloride (NaCl).

15. The potato salad pre-mix composition of claim 12, wherein the yellow mustard includes one or more of ground mustard seeds, water, vinegar, lemon juice, wine, salt, flavorings and spices.

16. The potato salad pre-mix composition of claim 12, wherein the sugar includes one or more of sucrose, glucose and fructose.

17. The potato salad pre-mix composition of claim 12, wherein the vinegar includes 5-20% acetic acid by volume.

18. The potato salad pre-mix composition of claim 12 is packaged in one of a small-sized jar, a medium-sized jar and a large-sized jar, wherein the small-sized jar contains 11.25 ounces of the potato salad pre-mix composition, wherein the medium-sized jar contains 22.5 ounces of the potato salad pre-mix composition, wherein the large-sized jar contains 45 ounces of the potato salad pre-mix composition.

19. The potato salad pre-mix composition of claim 12 is mixed with one or more of cooked potatoes, boiled eggs, diced celery, and diced onion to obtain potato salad.
